(19) United States
(12) Patent Application Publication
(10) Pub. No.: US 2023/0332733 A1
(43) Pub. Date: Oct. 19, 2023

(54) DEVICE COMPATIBLE MOUNTING STAND

(71) Applicants: Steven Wai-Tong Cheng, Plainview, NY (US); Sergio Portella DeAlbuquerque, Plainview, NY (US)

(72) Inventors: Steven Wai-Tong Cheng, Plainview, NY (US); Sergio Portella DeAlbuquerque, Plainview, NY (US)

(21) Appl. No.: 18/107,467

(22) Filed: Feb. 8, 2023

Related U.S. Application Data
(60) Provisional application No. 63/308,809, filed on Feb. 10, 2022.

(51) Int. Cl. F16M 11/22; F16M 11/04

(52) U.S. Cl. CPC F16M 11/22; F16M 11/04; F16M 2200/08; F16M 2200/00

(57) ABSTRACT

An apparatus for mounting devices onto a surface is disclosed. In some implementations, the apparatus comprises a base portion and a top portion. The base portion can support a number of sections that can be independently assembled in some implementations. The top portion may be compatible or compliant with VESA standards in some implementations. The top portion may be adjustable, tiltable, or rotatable in some implementations. In some implementations, a hollow interior of the apparatus may facilitate cable and/or wire management. In some implementations, the geometry of the apparatus can enable the weight of the device to pass directly through the center of gravity of apparatus, thereby ensuring the stability of the apparatus and the device.

### RELATED APPLICATIONS

This application claims the benefit of U.S. Application No. 63/308,809, entitled “Standards compliant, multi-part floor stand with adjustable VESA plate and optional security integrated,” filed on Feb. 10, 2022, which is incorporated herein by reference in its entirety.

### TECHNICAL FIELD

Embodiments relate generally to systems for mounting devices, and more particularly, to device compatible mounting assemblies for mounting devices onto different types of stands.

### BACKGROUND

Originally, mounting systems compatible with VESA (Video Electronics Standards Association) standards enabled devices such as monitors, televisions, and large display devices to be fixed permanently and securely through VESA ready mounting systems. With the advent of compact personal computers (PC) and tablet-based touch screens, interactive displays, and other touch-feedback digital signage, VESA mounting standards spread to smaller devices and many touch panel, tablet enclosures and other such devices now enable VESA compatible mounting.

VESA compatible or VESA ready display solutions may be powered using low voltage wiring, such as but not limited to CAT5/PoE networking cable, which can carry both power and data. Such low voltage powering setups may require a type of adapter or dongle to transform a single low-voltage line into a line that can transmit both power and data. However, concealing these wires within such VESA ready or VESA compatible display solutions may be a challenge.

Designs in the prior art, such as those shown in U.S. Pat. Nos. 9,189,928 B2 and D671,545, generally assume that the device to be mounted onto a floor stand is a tablet. Such designs may not offer any support for hidden cable or wire management for VESA ready or VESA compatible devices. This lack of support may render such apparatus inappropriate for the vast majority of display setups that require wires/cables to be hidden for better aesthetics and a clean/neat look.

Designs shown in the prior art may need access to wall outlet power and may not provide void space or empty slots for accommodating an auxiliary power supply or external power pack aesthetically, e.g., by hiding such power connections/sources. For example, designs in the prior art may be suited to accommodate a device that has an internal battery, e.g., a tablet device. This constraint may increase setup time and labor costs if additional wiring needs to be run to or near the unit so as to accommodate devices connected to an external power source. Alternatively, if a power pack is used with these prior art designs, the power pack may be fully visible in the open, resulting in a messy look or the power pack being exposed to unauthorized removal, e.g., theft.

Floor standing mount products in the prior art, such as those shown in U.S. Pat. No. 9,189,928 B2, have stems or center columns that may be manufactured as a single, long piece. While such a design may lower the cost of production of such stands, a single long piece is typically more expensive to ship, e.g., as shipping costs may be based on volumetric weight and not the actual weight of the shipment. In applications involving frequent transportation of floor stands, e.g., from one venue to another, such as but not limited to, an exhibition or a tradeshow venue, floor stand designs in the prior art built as a single long piece may incur high shipping costs, more so if such stands are transported as passenger baggage on airplanes, e.g., due to oversize charges.

In situations where multiple stands are required with different mounting requirements, e.g., fixed and secure stands, mobile and secure stands, or mobile and non-secure stands, users may need to purchase additional mounting hardware or multiple floor stands. Otherwise, users may be limited to the mounting options supported by the purchased stand. Also, if changes need to be made after the stand is setup, e.g., last minute changes, the lack of installation flexibility may result in significant constraints, especially if any related security requirements change.

Designs in the prior art, such as the ones shown in U.S. Pat. Nos. 9,189,928 B2 and D671,545, may not provide a security option to prevent theft or unauthorized removal of the floor stand. The lack of a security option may render these prior art designs vulnerable to vandalism and/or theft when the stands are placed in locations without adequate external security mechanisms.

Many designs in the prior art offer a fixed display angle (e.g., U.S. Pat. No. D671,545) or a limited range of display angles (e.g., U.S. Pat. No. 9,189,928 B2). This constraint may limit the use of self-standing kiosks deploying such designs as tall or short people may not be able to see the information displayed properly if the display is fixed and the height of the display is not adjustable.

Therefore, device mount designs in the prior art may not always lead to an optimal result. For example, in some scenarios, stands based on the designs shown in the prior art may not be secured against theft or unauthorized removal. In others, the total long-term cost of ownership may be high due to higher transportation costs associated with such designs. For setups with no nearby power, auxiliary or external power packs may be left out in the open with exposed wiring, which may affect the aesthetics of the display and the security of the device used for the display. Also, users who are tall or short may experience problems viewing the display if the display and/or the stand on which the display is mounted is not positioned at a convenient reading angle.

Some implementations were conceived in light of the above-mentioned needs, problems, and/or limitations, among other things.

### SUMMARY

Some implementations include a floor stand apparatus for mounting an electronic device. In some implementations, the floor stand apparatus comprises a device mounting plate. In some implementations, the device mounting plate can be configured to mount an electronic device onto the device mounting plate. In some implementations, the device mounting plate comprises one or more VESA compatible hole patterns. In some implementations, the device mounting plate comprises one or more device mounting plate apertures. In some implementations, the device mounting plate comprises a surface bounded around part or all of a perimeter of the surface with one or more of an edge or a lip.

In some implementations, the floor stand apparatus comprises one or more stems. In some implementations, the one or more stems can be hollow and can include void space. In some implementations, the void space can be configured to allow passage of the one or more of wires or cables.

In some implementations, the floor stand apparatus comprises a base plate. In some implementations, the base plate can be configured to be affixed to a surface. In some implementations, the base plate can comprise a curved slot configured to enable one or more of wires or cables to pass through the base plate. In some implementations, the base plate can be affixed to the surface using one or more of one or more screws, one or more bolts, one or more anchors, or mechanical fasteners.

In some implementations, the device mounting plate, the one or more stems, and the base plate can be assembled together through one or more of mechanical fasteners or a non-mechanical fastening mechanism. In some implementations, the one or more stems can together connect the device mounting plate to the base plate.

In some implementations, the floor stand apparatus comprises a Kensington lock slot.

In some implementations, the floor stand apparatus comprises a cover plate. In some implementations, the cover plate when affixed to the base plate can form void space between the cover plate and the base plate. In some implementations, the void space can be configured to accommodate one or more of wires or cables.

Some implementations include a stand apparatus for mounting an electronic device. In some implementations, the stand apparatus comprises a device mounting plate. In some implementations, the device mounting plate can be configured to mount an electronic device onto the device mounting plate. In some implementations, the device mounting plate comprises one or more VESA compatible mounting patterns that can be configured to interface with a VESA compatible device. In some implementations, the device mounting plate comprises one or more device mounting plate apertures that can be configured to enable attachment of a component to the apparatus. In some implementations, the device mounting plate comprises a surface bounded around part or all of a perimeter of the surface with one or more of an edge or a lip.

In some implementations, the stand apparatus comprises a top stem. In some implementations, the top stem can be configured with a bend at one end of the top stem. In some implementations, a curvature of the bend in the top stem can align with a center of gravity of the stand apparatus. In some implementations, the stand apparatus comprises a bottom stem. In some implementations, the top stem and the bottom stem can be hollow and comprise void space. In some implementations, the void space can be configured to allow passage of one or more of wires or cables through the top stem and the bottom stem to the device mounting plate and the base plate.

In some implementations, the stand apparatus comprises a base plate. In some implementations, the base plate can be configured to be affixed to a surface. In some implementations, the base plate can be affixed to the surface using one or more of one or more screws, one or more bolts, one or more anchors, or mechanical fasteners.

In some implementations, the device mounting plate, the top stem, the bottom stem, and the base plate can be assembled together through one or more of mechanical fasteners or a non-mechanical fastening mechanism. In some implementations, the top stem and the bottom stem can together connect the device mounting plate to the base plate.

In some implementations, the stand apparatus comprises a Kensington lock slot.

In some implementations, the stand apparatus comprises a cover plate. In some implementations, the cover plate when affixed to the base plate can form void space between the cover plate and the base plate. In some implementations, the void space can be configured to accommodate one or more of wires or cables.

In some implementations, the stand apparatus comprises one or more conjoining collars. In some implementations, the one or more conjoining collars can be used to assemble the top stem, the middle stem, the bottom stem, and the base plate together.

Some implementations include an apparatus for mounting an electronic device. In some implementations, the apparatus comprises a device mounting plate. In some implementations, the device mounting plate is configured to mount an electronic device onto the device mounting plate.

In some implementations, the apparatus comprises a top stem. In some implementations, the apparatus comprises a middle stem. In some implementations, the apparatus comprises a bottom stem.

In some implementations, the apparatus comprises a base plate. In some implementations, the base plate can be configured to be affixed to a surface.

In some implementations, the device mounting plate, the top stem, the middle stem, the bottom stem, and the base plate can be assembled together through one or more of a mechanical or a non-mechanical fastening mechanism. In some implementations, the top stem, the middle stem, and the bottom stem can connect the device mounting plate to the base plate.

In some implementations, the device mounting plate can be attached to the top stem through one or more of a mechanical fastening mechanism or a non-mechanical fastening mechanism.

In some implementations, the apparatus comprises one or more conjoining collars. In some implementations, the one or more conjoining collars can be used to assemble the top stem, the middle stem, the bottom stem, and the base plate together.

In some implementations, the apparatus comprises a Kensington lock slot.

### BRIEF DESCRIPTION OF THE DRAWINGS

FIG. 1 shows an exploded view of an example stand apparatus in accordance with some implementations.

FIG. 2 shows an exploded view of a portion of an example stand apparatus in accordance with some implementations.

FIG. 3 shows an exploded view of a portion of an example stand apparatus in accordance with some implementations.

FIG. 4 shows cutaway views of a portion of an example stand apparatus in accordance with some implementations.

FIG. 5 shows exploded views of a portion of an example stand apparatus in accordance with some implementations.

FIG. 6 shows exploded views of a portion of an example stand apparatus in accordance with some implementations.

FIG. 7 shows sectional views of an example stand apparatus in accordance with some implementations.

FIG. 8 shows a perspective view of a portion of an example stand apparatus in accordance with some implementations.

FIG. 9 shows a perspective view of a portion of an example stand apparatus in accordance with some implementations.

FIG. 10 shows a side view of an example stand apparatus in accordance with some implementations.

FIG. 11 shows a side view of an example stand apparatus in accordance with some implementations.

FIG. 12 shows a side perspective view of an example installation of an example stand apparatus in an example scenario in accordance with some implementations.

FIG. 13 shows a perspective view of a portion of an example stand apparatus in accordance with some implementations.

FIG. 14 shows a side view of a portion of an example stand apparatus in accordance with some implementations.

FIG. 15 shows a cutaway view of a portion of an example stand apparatus in accordance with some implementations.

FIG. 16 shows an inside view of an example attachment to an example stand apparatus in accordance with some implementations.

FIG. 17 shows an example illustration of an example disassembled stand apparatus packed together in accordance with some implementations.

FIG. 18 shows perspective, front, and side views of a portion of an example stand apparatus in accordance with some implementations.

### DETAILED DESCRIPTION

Those of ordinary skill in the art will realize that the following detailed description of the present invention is illustrative and is not intended to be limiting in any way. Other embodiments of this invention will be apparent to those skilled in the art having the benefit of this disclosure.

The term “VESA” hereinafter refers to the VESA Mounting Interface Standard, also known as the VESA Mount, which is a family of standards defined by the Video Electronics Standards Association for mounting flat panel monitors, televisions (TVs), and other displays to floor stands and/or wall mounts. It can be implemented on devices such as, but not limited to, modern flat-panel monitors, TVs, as well as some specialized tablets designed for mounting.

The term “Kensington Slot” hereinafter refers to a Kensington Security Slot, which is part of an anti-theft system designed and patented by Kryptonite in 1999-2000 through U.S. Pat. Nos. 6,081,974, 6,317,936, and 6,360,405, in which a Kensington lock can be installed.

Some implementations include an apparatus that allows a VESA-ready device to be installed at a fixed location with a fixed or adjustable angle to enable viewers to see and/or read content displayed on the VESA-ready device. In some implementations, the apparatus can accommodate the VESA-ready device without the assistance of any other means or equipment.

In some implementations, the apparatus can be designed to comprise several pieces that can be combined into a single assembly. In some implementations, the assembly can be hollow in its center column, thereby enabling wiring to be hidden inside the center column. In some implementations, the apparatus can be secured to a fixed location using thru bolts affixed by means of thru holes designed in the weighted base of the apparatus. In some implementations, the apparatus can be secured to a fixed location with a Kensington lock, or other suitable means.

A growing number of displays, including flat-panel monitors, TVs, specialized tablets, and tablet enclosures, are becoming smaller and facilitating more interaction with users. Such devices may need to be installed or placed onto a surface for display to or interaction with users. For example, devices with such displays may need to be positioned or located as free-standing floor displays. Also, the displays may need to be positioned to enable viewing by all visitors.

The disclosed apparatus enables VESA-ready devices to be readily mounted. In some implementations, the apparatus comprises a VESA mounting plate. In some implementations, the VESA mounting plate has mounting patterns that are compatible with common VESA sizes, such as but not limited to 75×75 mm or 100×100 mm. In some implementations, the mounting plate can include a center through hole to enable a cable or a wire to pass through the mounting plate.

In some implementations, the VESA mounting plate may have additional through or threaded holes, with or without a countersink, to enable a portion/part/piece of the apparatus to be fastened to the next portion/part/piece of the apparatus through mechanical fasteners. In some implementations, the VESA mounting plate may have additional features machined, built, or otherwise added into the plate to enable a portion/part/piece of the apparatus to be attached to the next portion/part/piece of the apparatus through chemical or other non-mechanical means.

In some implementations, the VESA mounting plate may comprise a surface, such as a tray, shelf, or other surface, to enable placement of items near the VESA-ready device mounted onto the VESA mounting plate. In some implementations, the surface may comprise a lip or an edge around some or all sections of the perimeter of the surface to prevent the aforementioned items from falling off the surface. The described surface can be, but is not limited to, a keyboard tray, a Point-of-Sale printer shelf, a contoured barcode scanner holder, or a combination thereof.

In some implementations, the disclosed apparatus includes a top stem (“Top Stem”). In some implementations, the Top Stem includes a bend or a curved surface shaped in such a way that the curvature of the bend aligns with the center of gravity of the apparatus so as to minimize the probability of the apparatus being tipped over during use. In some implementations, the Top Stem may be affixed to the VESA mounting plate through one or more mechanical fasteners. In some implementations, the Top Stem may be attached to the VESA mounting plate through a non-mechanical method, such as via chemical bonding agents, epoxies, welding, or other methods. In some implementations, the Top Stem may be manufactured together with the VESA mounting plate as a single piece. In some implementations, the end of the Top Stem that is attached to the VESA mounting plate may be flexible, e.g., with a tilting, rotating, or other mechanism that enables the Top Stem and/or the VESA mounting plate to be adjusted after assembly. In some implementations, the Top Stem may be designed such that the center of the VESA mounting plate coincides with the center of mass of the apparatus so as to enable the apparatus to support heavy objects while minimizing the chances of the apparatus tipping over. In some implementations, the Top Stem may be hollow from one end to the other end so as to enable cables and/or wiring to pass through the Top Stem to the above VESA mounting plate.

Some implementations of the apparatus comprise a bottom stem (“Bottom Stem”). In some implementations, the Bottom Stem can be attached to the Top Stem to increase the height of the apparatus. In some implementations, an outer diameter of the Bottom Stem may align with an outer diameter of the Top Stem, thereby improving the aesthetics of the apparatus. In some implementations, an inner diameter of the Bottom Stem may align with an inner diameter of the Top Stem, thereby enabling the use of a symmetrical and/or reversible part to assemble the Top Stem and the Bottom Stem together. In some implementations, an outer diameter of the Bottom Stem may not align with an outer diameter of the Top Stem so as to facilitate the possibility of a telescopic stem design, which may enable adjustments and variations to height of the apparatus.

In some implementations, an inner diameter of the Bottom Stem may not align with an inner diameter of the Top Stem, thereby requiring use of an asymmetrical and/or non-reversible part to assemble the pieces together. In some implementations, the Bottom Stem may be hollow so as to enable cables and/or wiring to pass through the Bottom Stem. In some implementations, the Bottom Stem may have additional through or threaded holes, with or without a countersink, attached to one end of the Bottom Stem so as to enable the one end of the Bottom Stem to be fastened to the next part/piece/portion of the apparatus through mechanical fasteners. In some implementations, the Bottom Stem can have additional features machined, built, or otherwise added into the Bottom Stem to enable an end of the Bottom Stem to be attached to the next part/piece/portion of the apparatus through chemical and/or other non-mechanical means.

In some implementations, the Bottom Stem may have an in-built Kensington Slot, also known as a Kensington lock slot, built into the Bottom Stem so as to enable the apparatus to be secured by the means of a Kensington lock with attached tether. In some implementations, the Kensington Slot can be attached to or integrated with the apparatus as a separate, add-on part.

Some implementations of the apparatus comprise a conjoining collar (“Conjoining Collar”). In some implementations, the Conjoining Collar is a cylindrical part. In some implementations, the Conjoining Collar connects the Top Stem to the Bottom Stem. In some implementations, a Conjoining Collar comprises three sections along its axis—two end sections, one at each end, with their outer diameters aligning with inner diameters of the Top Stem and the Bottom Step, and one flanged section in between the two end sections. An outer diameter of the flanged section aligns with an outer diameter of one or more of the Top Stem or the Bottom Stem. In some implementations, the two end sections may be identical so as to enable each end to be used interchangeably during installation. Such a symmetrical Conjoining Collar design may simplify manufacturing, lower production costs, and enable seamless assembly of the apparatus. In some implementations, the two end sections may not be identical, thereby preventing the ends from being used interchangeably. Such an asymmetrical Conjoining Collar design may enable a direction-specific install, where the associated parts can only be assembled in a single direction.

In some implementations, the Conjoining Collar comprises one or more threaded holes on an outer circumference of the two end sections to facilitate the installation of the Conjoining Collar through matching set screws. In some implementations, when the Conjoining Collar is connected to a Top/Bottom Stem at each end, the set screws can be turned and slowly advance outwards, acting as a clamp to lock the Top/Bottom Stem's position relative to the Conjoining Collar. In some implementations, the Conjoining Collar comprises two threaded hole and set screw combinations for each of the two end sections. In some implementations, a set of two threaded holes is located on opposite faces of a circumference of the Conjoining Collar, resulting in a total of four threaded hole and set screw combinations. Such a design may reduce the number of holes on the Top/Bottom Stem pieces so as to improve the aesthetics of the assembly.

In some implementations, a Conjoining Collar comprises four threaded hole and set screw combinations for each of the two end sections located at each of the four quadrant points on a circumference of the Conjoining Collar, resulting in a total of eight threaded hole and set screw combinations. Such a design provides additional stability without significantly impacting the aesthetics of the assembly. In some implementations, the Conjoining Collar may feature any number of threaded hole and set screw combinations for each of the two end sections. In some implementations, the threaded holes may be located at any place on a circumference of the Conjoining Collar. In some implementations, the Conjoining Collar may be hollow so as to allow cables and/or wiring to pass through the Conjoining Collar to the Top/Bottom Stem. In some implementations, the Conjoining Collar may be made with, incorporate, integrate, or allow the attachment of a surface to the apparatus. In some implementations, the surface may function as a tray, shelf, or other such surface to support placement of items around one or more of the Top Stem, the Bottom Stem, or a mid-section of the apparatus. In some implementations, the surface may feature a lip or an edge around some or all sections of a perimeter of the surface to prevent items from falling off the surface. For example, such a surface can be used to hold brochures or marketing material, as a Point-of-Sale printer shelf, as a contoured barcode scanner holder, or as a combination of one or more of a paper/book holder, a printer shelf, or a barcode scanner holder.

Some implementations of the apparatus comprise a middle stem (“Middle Stem”). In some implementations, the Middle Stem is placed between the Top Stem and the Bottom Stem to make the apparatus, i.e., the assembly of the Top Stem and the Bottom Stem, taller. One or more Conjoining Collars may be used in some implementations comprising the Middle Stem. In some implementations, the Middle Stem may be hollow to enable cables and/or wiring to pass through the Middle Stem. In some implementations, the Top Stem and the Bottom Stem can be designed to be longer in length to reduce the length of the Middle Stem or obviate the need for the Middle Stem. Increasing the length of the Top Stem and/or the Bottom Stem may increase shipping costs as the shipping size of the package may increase due to an increase in the length of the stem(s). In some implementations where a Middle Stem is not present, internal diameters of the Top Stem and the Bottom Stem may align with internal diameters of the Conjoining Collar's end sections. The Middle Stem may be skipped where a shorter apparatus (in height) is needed for example.

Some implementations of the apparatus comprise a base plate (“Base Plate”) that can be connected to the Bottom Stem. In some implementations, the Base Plate enables the apparatus to stand by itself without the need for additional mechanical, chemical, or other fastening materials or hardware. In some implementations, the Base Plate can be affixed to the Bottom Stem using one or more screw(s), rivet(s), or other mechanical fastening mechanism(s). In some implementations, the Base Plate may be attached to the Bottom Stem using a non-mechanical fastening mechanism, such as one using chemical bonding agents, epoxies, welding, or other manufacturing methods. In some implementations, the Base Plate may comprise one or more cable slots to enable cables/wires to pass through the hollow center of the Bottom Stem into the Base Plate. In some implementations, the cable slot of the Base Plate can be designed to enable the apparatus to be secured to a fixed location, e.g., by means of heavy-duty bolts, screws, or other mechanical fastening mechanisms.

Some implementations of the apparatus comprise a cover cap (“Cover Cap”) that aligns with the shape and the dimensions of a perimeter of the Base Plate. In some implementations, the Cover Cap creates void space between the Base Plate and the inside of the Cover Cap, thereby permitting peripherals such as, but not limited to, battery charging packs, data connectivity hubs, cables, and other interconnects to be concealed within the apparatus. Such concealment allows for a clean, aesthetic look with concealed wiring. In some implementations, the Cover Cap may be removable. In some implementations, the Cover Cap may incorporate magnets that are placed in the Cover Cap such that the magnets enable direct contact of the Cover Cap with a ferrous-based Base Plate, thereby preventing unintended motion of the Cover Cap if the Cover Cap is nudged or gently moved. Such a design enables the Cover Cap to be removed by applying force to disengage the magnets within the Cover Cap from the ferrous-based Base Plate. In some implementations, the Cover Cap may comprise threaded holes that align with screws installed through the Base Plate, thereby preventing unauthorized removal of the Cover Cap. In some implementations, the Cover Cap may be attached to the Base Plate by means of a chemical or other non-mechanical bonding mechanism, such as but not limited to, glues, epoxies, or welding methods, some of which may prevent the Cover Cap from being removed from the Base Plate.

Some implementations include a compact carton designed to enable ground transport of the apparatus. In some implementations, the compact carton enables the apparatus to be packed in as little a space as possible to minimize costs arising from volumetric weight-based shipping.

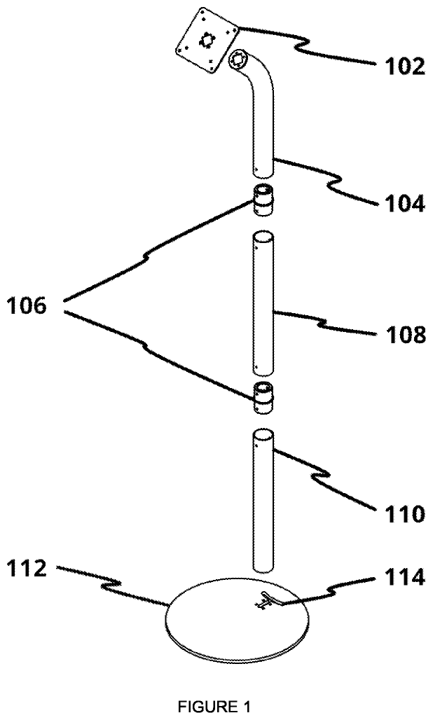

FIG. 1 shows an exploded view of an example stand apparatus in accordance with some implementations. FIG. 1 shows a Device Mounting Plate (102), a Top Stem (104), Conjoining Collars (106), a Middle Stem (108), a Bottom Stem (110), and a Base Plate (112) of an example unassembled stand in accordance with some implementations. In some implementations, the Base Plate (112) includes an integrated curved slot (114) built into the Base Plate (112).

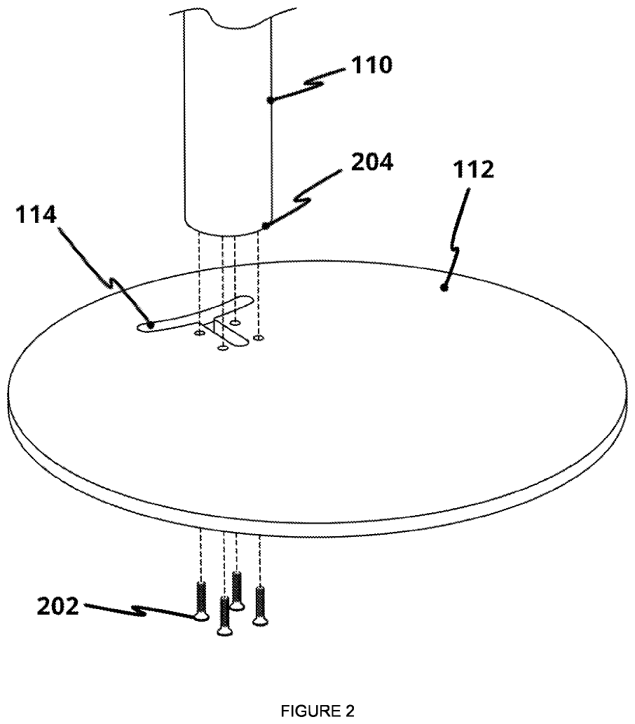

FIG. 2 shows an exploded view of a portion of an example stand apparatus in accordance with some implementations. FIG. 2 shows the Bottom Stem (110) connected to the Base Plate (112) through one or more screws (202) at one end (204) of the Bottom Stem (110) near the integrated curved slot (114). The stand may be assembled using mechanical as well as non-mechanical fastening methods such as, but not limited to, mechanical or chemical fasteners.

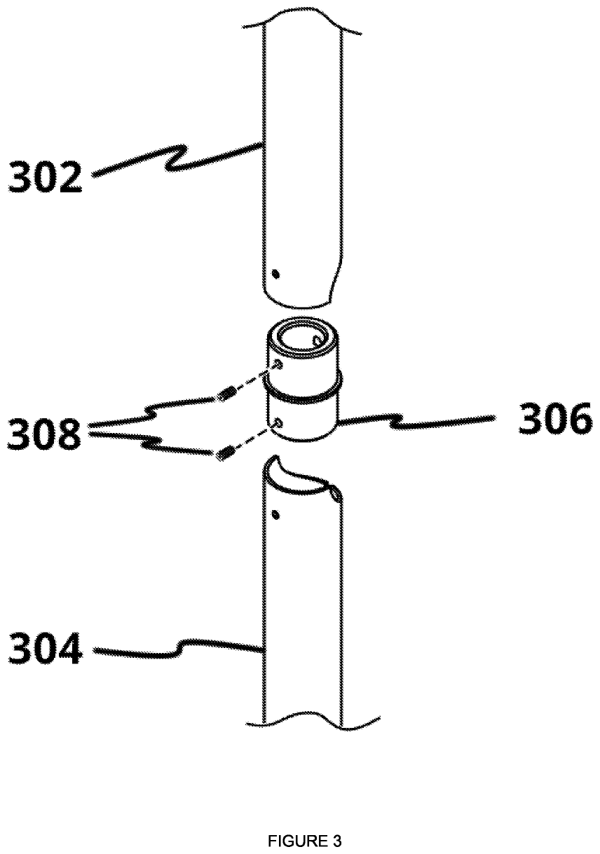

FIG. 3 shows an exploded view of a portion of an example stand apparatus in accordance with some implementations. FIG. 3 shows a portion of the apparatus between two stem pieces (302 and 304), both of which are hollow on the inside. The two stem pieces (302 and 304) can be assembled using a Conjoining Collar (306), which may have set screws (308) embedded inside.

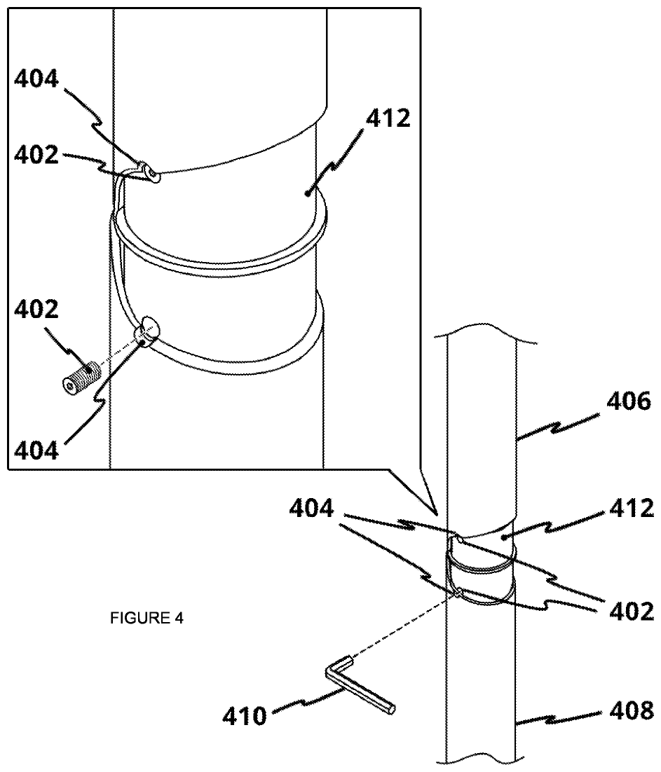

FIG. 4 shows cutaway views of a portion of an example stand apparatus in accordance with some implementations. FIG. 4 shows set screws (402) and corresponding thru holes (404) on two stem pieces (406 and 408) through which the set screws (402) pass to secure a stem piece to a Conjoining Collar (412). In some implementations, turning the set screws counter-clockwise using an example tool (410) physically locks a stem piece and the Conjoining Collar (412) in place, thus securing the two stem pieces (406 and 408) together via the Conjoining Collar (412).

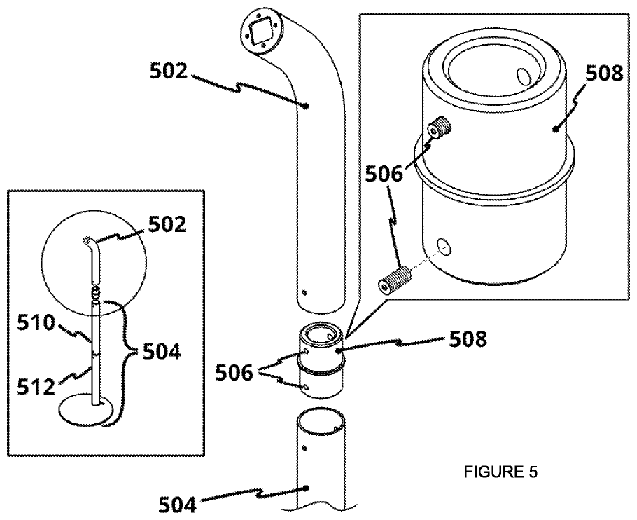

FIG. 5 shows exploded views of a portion of an example stand apparatus in accordance with some implementations. FIG. 5 shows how the Top Stem (502) can be affixed to the rest of the stand apparatus (504) using one or more set screws (506) and a Conjoining Collar (508). In some implementations, identical conjoining collars can be used interchangeably to connect the Top Stem (502) and the Middle Stem (510) as well as the Middle Stem (510) and the Bottom Stem (512). In some implementations, the Middle Stem (510) may be omitted by connecting the Top Stem (502) to the Bottom Stem (512), thereby reducing the height of the stand apparatus.

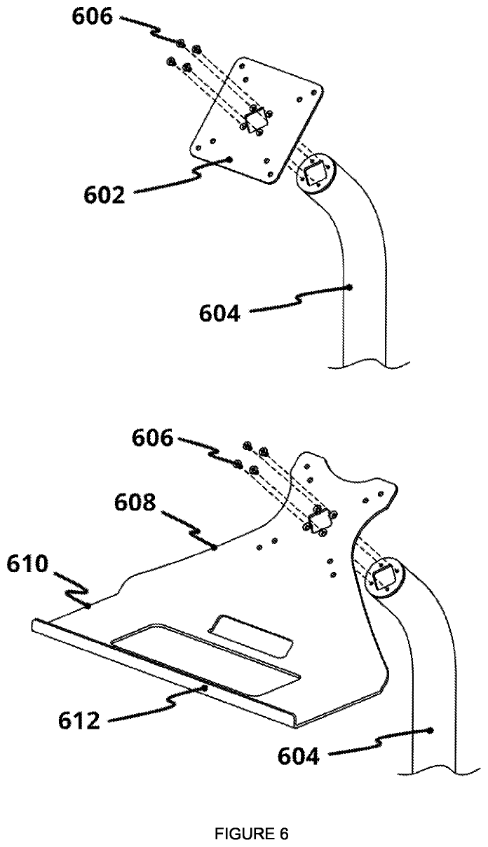

FIG. 6 shows exploded views of a portion of an example stand apparatus in accordance with some implementations. FIG. 6 shows an exploded unassembled view of an example VESA Mounting Plate (602). The VESA Mounting Plate (602) can be affixed to a Top Stem (604) with one or more screws (606). In some implementations, the VESA Mounting Plate (602) can be attached to the Top Stem (604) using one or more of mechanical or non-mechanical fastening mechanisms. The VESA Mounting Plate (602) may be assembled using mechanical as well as non-mechanical fastening methods such as, but not limited to, mechanical or chemical fasteners.

FIG. 6 also shows an exploded unassembled view of another example VESA Mounting Plate (608). In some implementations, the extended portion (610) of the VESA Mounting Plate (608) can serve as a tray for a keyboard, a scanner, a printer, or other peripherals. The extended portion (610) can have an edge or a lip (612) to prevent objects placed on the extended portion (610) from falling off the VESA Mounting Plate (608). The VESA Mounting Plate (608) can be affixed to the Top Stem (604) with one or more screws (606). Both VESA Mounting Plates (602 and 608) can support many VESA mounting patterns, e.g., VESA 75×75 and VESA 100×100.

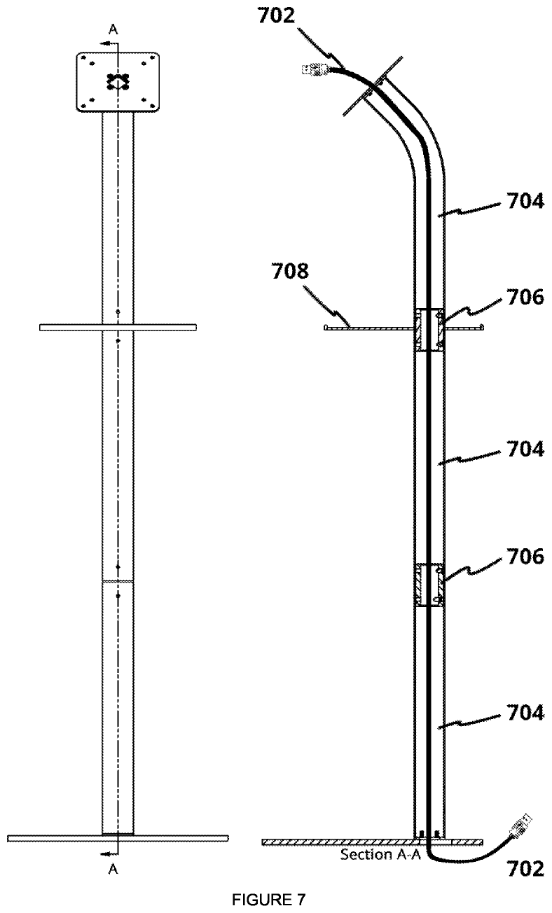

FIG. 7 shows sectional views of an example stand apparatus in accordance with some implementations. FIG. 7 shows one or more cables (702) passing through a hollow section (704) of the stand apparatus. Such a design enables cables, device add-ons or accessories, or wires connected to a device mounted on the stand apparatus to be hidden within the hollow section (704) of the stand apparatus. FIG. 7 also shows a Conjoining Collar (706) with an optional extended section (708). The optional extended section (708) can be built into the Conjoining Collar (706) in some implementations. In some implementations, the optional extended section (708) can be attached to the Conjoining Collar (706). The optional extended section (708) can serve, e.g., as a tray, to hold objects.

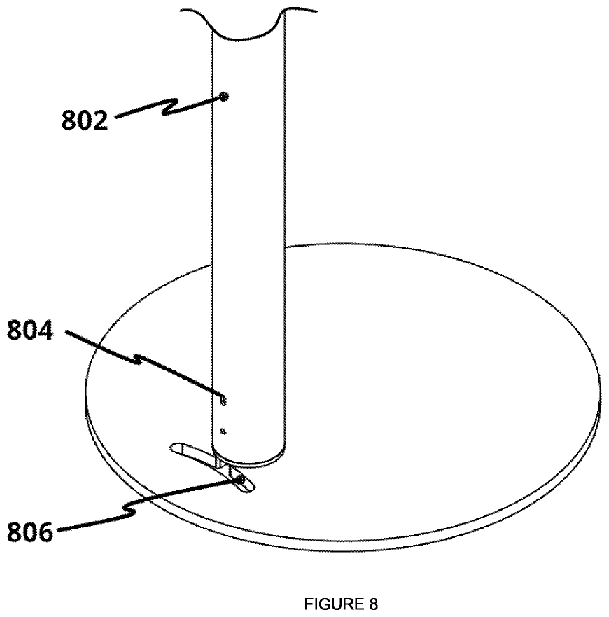

FIG. 8 shows a perspective view of a portion of an example stand apparatus in accordance with some implementations. FIG. 8 shows a portion of a Bottom Stem (802) that includes a Kensington lock slot (804) (i.e., a Kensington Slot). In some implementations, the Kensington Slot (804) is built into the Bottom Stem (802). The Kensington Slot (804) is attached to the Bottom Stem (802) in some implementations. The Kensington Slot (804) enables the stand apparatus to be secured against unauthorized removal, e.g., theft. The Kensington cable tether can pass through a hollow section of the stand apparatus into a curved slot (806) of the stand apparatus, thereby concealing the tether from outside view. The Kensington Slot (804) enables the stand apparatus to be portable and mobile, but without being exposed to the risk of theft.

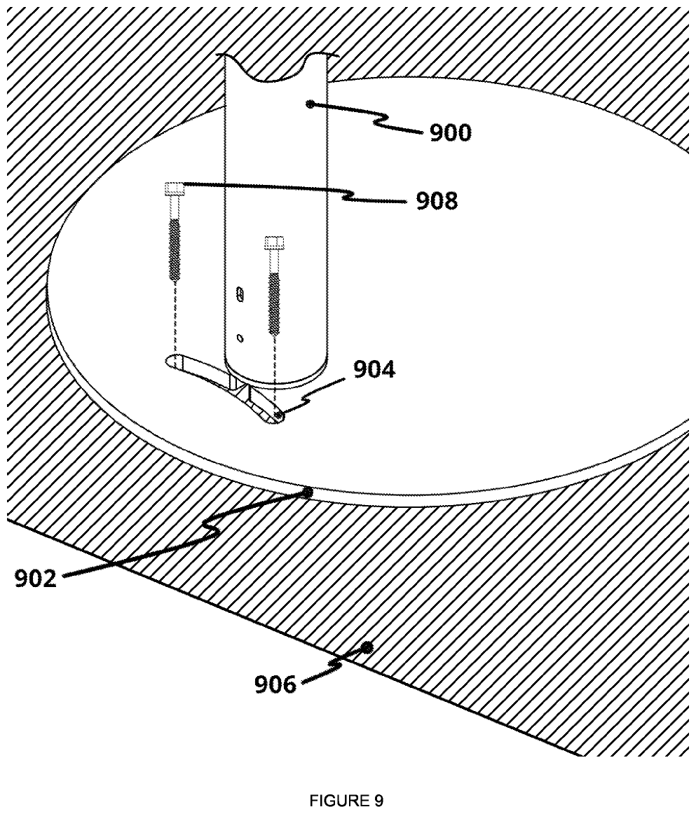

FIG. 9 shows a perspective view of a portion of an example stand apparatus in accordance with some implementations. FIG. 9 shows a Base Plate (902) and a built-in curved slot (904). FIG. 9 also shows the stand apparatus (900) being securely fastened to a fixed surface (906) using fasteners (908). Such fasteners can include one or more screws, bolts, or anchors.

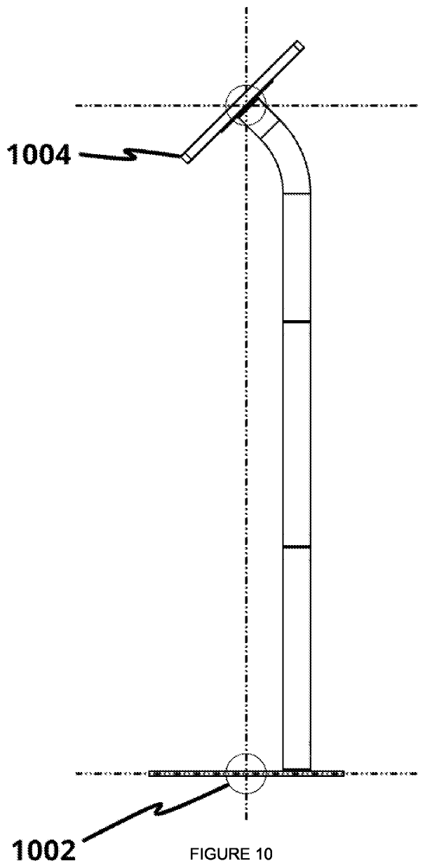

FIG. 10 shows a side view of an example stand apparatus in accordance with some implementations. FIG. 10 shows the alignment of the center of gravity of the Base Plate (1002) with the center of a mounted device (1004). Such alignment may reduce the probability of the stand apparatus tipping over, e.g., when the stand is pushed or pulled from its standing position.

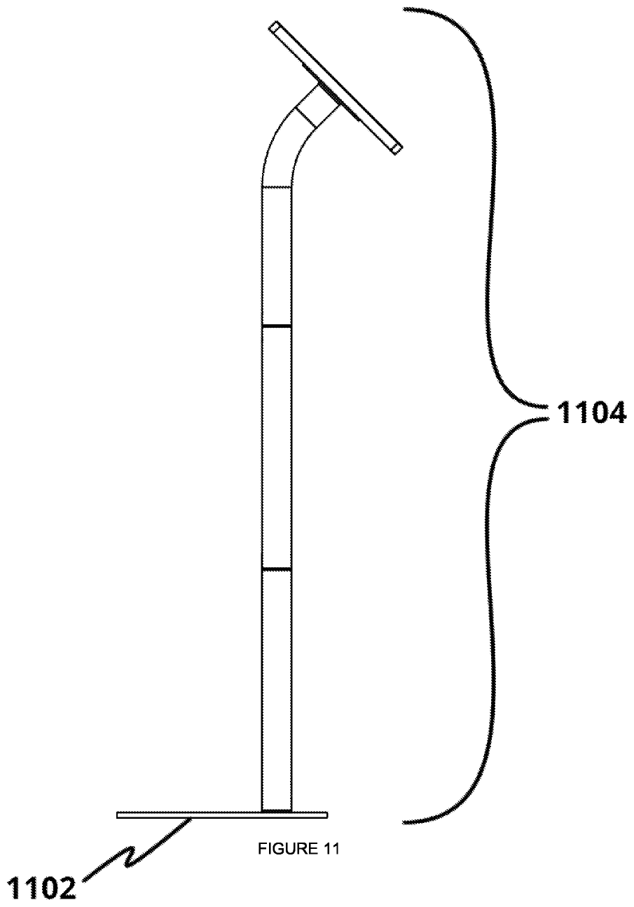

FIG. 11 shows a side view of an example stand apparatus in accordance with some implementations. FIG. 11 shows a Base Plate (1102) and the rest of the stand apparatus (1104) assembled such that the Base Plate (1102) is offset from the rest of the stand apparatus (1104) by 180 degrees. In such an implementation, the center of gravity of the stand apparatus does not pass through the Base Plate (1102), unlike the case of the stand apparatus shown in FIG. 10.

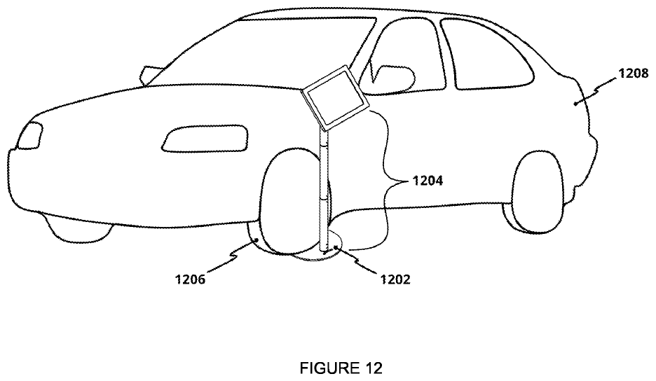

FIG. 12 shows a side perspective view of an example installation of an example stand apparatus in an example scenario in accordance with some implementations. FIG. 12 shows a Base Plate (1202) of the example stand apparatus (1204) weighted down using a wheel (1206) of a car (1208). In some implementations, the Base Plate (1202) can be weighted down or clamped down with other heavy objects so as to secure the stand apparatus to a fixed surface. This allows the stand apparatus to be integrated with the design of any exhibit that requires a stand apparatus.

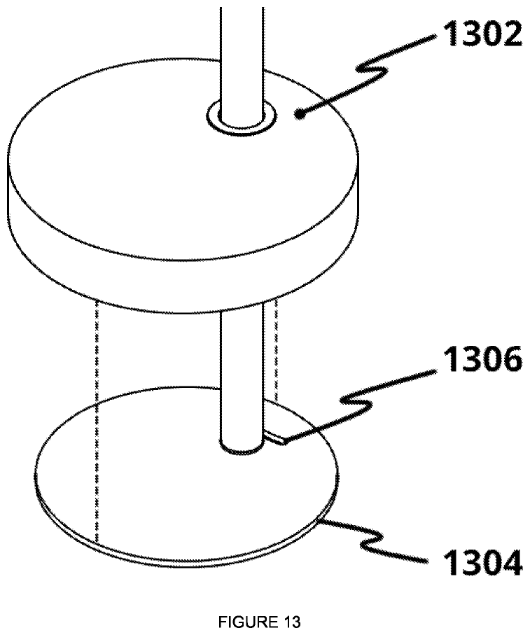

FIG. 13 shows a perspective view of a portion of an example stand apparatus in accordance with some implementations. FIG. 13 shows a Cover Cap (1302) with outer dimensions identical to outer dimensions of a Base Plate (1304). The Cover Cap (1302) can be designed to align with the size and the shape of the Base Plate (1304) so as to fit over the Base Plate (1304). Cables and/or wires can pass through the curved slot (1306) in the Base Plate (1304) into the void space created by the Cover Cap (1302) over the Base Plate (1304).

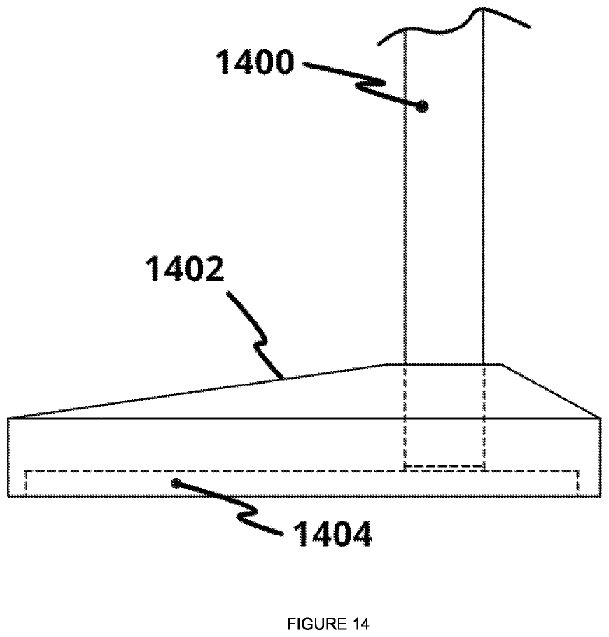

FIG. 14 shows a side view of a portion of an example stand apparatus in accordance with some implementations. FIG. 14 shows a Cover Cap (1402) assembled onto a Base Plate (1404) of the example stand apparatus (1400) without the use of any fasteners or fastening mechanisms.

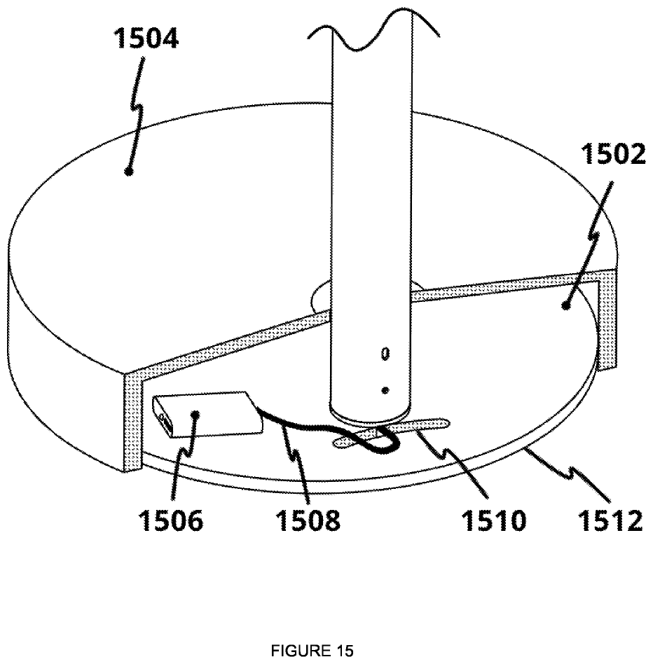

FIG. 15 shows a cutaway view of a portion of an example stand apparatus in accordance with some implementations. FIG. 15 shows void space (1502) under a Cover Cap (1504). FIG. 15 also shows add-ons or accessories such as USB port packs and/or battery packs (1506) and cables and/or wires (1508) hidden within the void space (1502). In some implementations, other power and/or data connectivity hardware can be hidden within the void space (1502). For example, cables and/or wires (1508) can pass via a curved slot (1510) of the Base Plate (1512) into void space (1502).

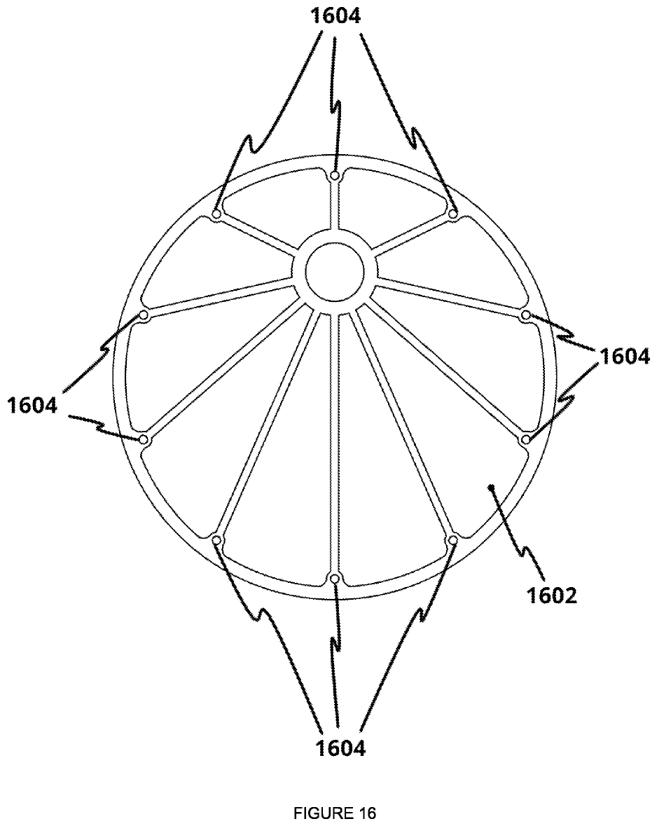

FIG. 16 shows an inside view of an example attachment to an example stand apparatus in accordance with some implementations. FIG. 16 shows the underside of a Cover Cap (1602) with magnets (1604) affixed to multiple points on an inside periphery of the Cover Cap (1602). In some implementations, the magnets (1604) enable the Cover Cap (1602) to be attached to a Base Plate. In some implementations, methods such as, but not limited to, adhesive tapes, chemical bonding agents, welding, epoxies, and/or any other chemical and/or mechanical fastening methods or mechanisms may be used to attach the Cover Cap (1602) to a Base Plate.

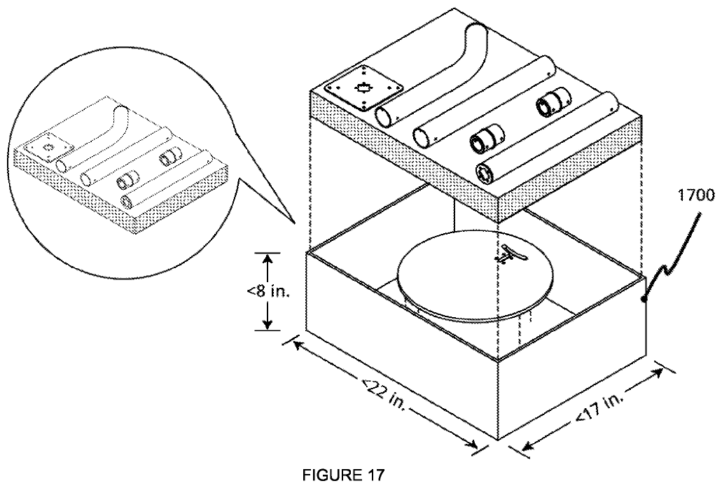

FIG. 17 shows an example illustration of an example disassembled stand apparatus packed together in accordance with some implementations. FIG. 17 shows a disassembled stand apparatus that is packed into a single box (1700). Such packing options enable the packed stand apparatus to fit into airplane carry-on luggage and/or checked-in luggage. Alternatively, such packages may incur lower costs when transported via grounded shipping, where the cost of transportation may be estimated based on volumetric weight. While dimensions of a packed stand apparatus may vary based on the packaging requirements, dimensions of less than 22 inches in length, 17 inches in width, and 8 inches in thickness are feasible as shown in FIG. 17, which may allow the package to be considered carry-on luggage for flights, thus saving the time and cost of having it being checked in.

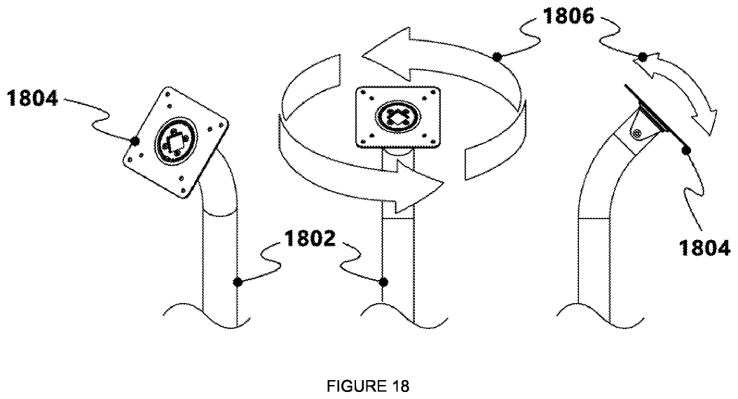

FIG. 18 shows perspective, front, and side views of a portion of an example stand apparatus in accordance with some implementations. FIG. 18 shows a Top Stem (1802) integrated into an adjustable, rotatable, and/or tiltable Device Mounting Plate (1804). The adjustable, rotatable, and/or tiltable Device Mounting Plate (1804) can be attached to the Top Stem (1802) in some implementations. Such attachment may be via mechanical or non-mechanical fastening mechanisms. An adjustable, rotatable, and/or tiltable Device Mounting Plate (1804) enables the mounted device to be rotated or swiveled (1806) to offer a desired viewing angle. This flexibility helps viewers with different physical characteristics (e.g., height) to view content on the device.

FIGS. 1 through 18 demonstrate some of the possible form factors or sizes that the disclosed invention can be made in. In these variants, the invention can be directly bolted and/or securely mounted onto any flat surface. Alternatively, the invention can be tethered to another object. A Kensington Slot can optionally be added to provide a limited degree of freedom for the invention to be moved around while preventing unauthorized removal of the apparatus. The invention is equipped to be installed using different mounting options for additional functionality and the descriptions and figured shown herein simply show some examples of possible configurations and should not be construed as a limit on potential embodiments.

It is contemplated that any optional feature of the inventive variations described may be set forth and claimed independently or in combination with any one or more of the features described herein. Reference to a singular item includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only”, and the like in connection with the recitation of claim elements, or for the use of a “negative” limitation. In the absence of the use of any such exclusive terminology, the term “comprising” in the claims shall allow for the inclusion of any additional element irrespective of whether a given number of elements are enumerated in the claim. Also, the addition of a feature could be regarded as transforming the nature of an element set forth in the claims. Except as specifically defined herein, all technical and scientific terms used herein are to be given as broad a commonly understood meaning as possible while maintaining the validity of below claims.

The breadth of the present invention is not to be limited to the examples provided and/or the subject specification, but rather only by the scope of the claim language. Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to each other or the claims. All references cited are incorporated by reference in their entirety. Although the foregoing invention has been described in detail for the purpose of clarity of understanding the invention, it is contemplated that certain modifications to the invention may be practiced within the scope of the claims below.

It is therefore apparent that there is provided in accordance with the various embodiments disclosed herein, systems for mounting devices onto stands, including stands mounted on floors.

While the disclosed subject matter has been described in conjunction with a number of embodiments, it is evident that many alternatives, modifications, and variations would be or are apparent to those of ordinary skill in the applicable arts. Accordingly, the Applicant intends to embrace all such alternatives, modifications, equivalents, and variations that are within the spirit and scope of the disclosed subject matter.

What is claimed is:

1. A floor stand apparatus for mounting an electronic device comprising:
a device mounting plate configured to mount an electronic device onto the device mounting plate;
one or more stems; and
a base plate configured to be affixed to a surface, wherein the device mounting plate, the one or more stems, and the base plate are assembled together through one or more of mechanical fasteners or a non-mechanical fastening mechanism, and wherein the one or more stems together connect the device mounting plate to the base plate, and wherein the base plate comprises a slot configured to enable one or more of wires or cables to pass through the base plate, wherein the slot can be one of a curved, a straight, or a compound shape slot.

2. The floor stand apparatus of claim 1, wherein the base plate is affixed to the surface using one or more of one or more screws, one or more bolts, one or more anchors, or mechanical fasteners.

3. The floor stand apparatus of claim 1, wherein the device mounting plate comprises one or more VESA compatible hole patterns.

4. The floor stand apparatus of claim 1, wherein the device mounting plate comprises one or more device mounting plate apertures.

5. The floor stand apparatus of claim 1, further comprising a Kensington lock slot.

6. The floor stand apparatus of claim 1, wherein the one or more stems are hollow and include void space, and wherein the void space is configured to allow passage of the one or more of wires or cables.

7. The floor stand apparatus of claim 1, further comprising a cover plate, wherein the cover plate when affixed to the base plate forms void space between the cover plate and the base plate, and wherein the void space is configured to accommodate the one or more of wires, add-ons, or cables.

8. The floor stand apparatus of claim 1, wherein the device mounting plate comprises a surface bounded around part or all of a perimeter of the surface with one or more of an edge or a lip.

9. A stand apparatus for mounting an electronic device comprising:
a device mounting plate configured to mount an electronic device onto the device mounting plate;
a top stem, wherein the top stem comprises a bend at one end of the top stem;
a bottom stem; and
a base plate configured to be affixed to a surface, wherein the device mounting plate, the top stem, the bottom stem, and the base plate are assembled together through one or more of mechanical fasteners or a non-mechanical fastening mechanism, and wherein the top stem and the bottom stem together connect the device mounting plate to the base plate, and wherein a curvature of the bend in the top stem aligns with a center of gravity of the stand apparatus.

10. The stand apparatus of claim 9, further comprising one or more conjoining collars, wherein the one or more conjoining collars are used to assemble the top stem, the middle stem, the bottom stem, and the base plate together.

11. The stand apparatus of claim 9, further comprising a Kensington lock slot.

12. The stand apparatus of claim 9, wherein the base plate is affixed to the surface using one or more of one or more screws, one or more bolts, one or more anchors, or mechanical fasteners.

13. The stand apparatus of claim 9, wherein the device mounting plate comprises one or more VESA compatible mounting patterns configured to interface with a VESA compatible device.

14. The stand apparatus of claim 9, wherein the device mounting plate comprises one or more device mounting plate apertures configured to enable attachment of a component to the apparatus.

15. The stand apparatus of claim 9, wherein the top stem and the bottom stem are hollow and comprise void space, and wherein the void space is configured to allow passage of one or more of wires or cables through the top stem and the bottom stem to the device mounting plate and the base plate.

16. The stand apparatus of claim 9, further comprising a cover plate, wherein the cover plate when affixed to the base plate forms void space between the cover plate and the base plate, and wherein the void space is configured to accommodate one or more of wires, add-ons, or cables.

17. The stand apparatus of claim 9, wherein the device mounting plate comprises a surface bounded around part or all of a perimeter of the surface with one or more of an edge or a lip.

18. An apparatus for mounting an electronic device comprising:
a device mounting plate configured to mount an electronic device onto the device mounting plate;
a top stem;
a middle stem;
a bottom stem; and
a base plate configured to be affixed to a surface, wherein the device mounting plate, the top stem, the middle stem, the bottom stem, and the base plate are assembled together through one or more of a mechanical or a non-mechanical fastening mechanism, and wherein the top stem, the middle stem, and the bottom stem connect the device mounting plate to the base plate, and wherein the device mounting plate is attached to the top stem through one or more of a mechanical fastening mechanism or a non-mechanical fastening mechanism.

19. The apparatus of claim 18, further comprising one or more conjoining collars, wherein the one or more conjoining collars are used to assemble the top stem, the middle stem, the bottom stem, and the base plate together.

20. The apparatus of claim 18, further comprising a Kensington lock slot.
